(19) United States
(12) Patent Application Publication
(10) Pub. No.: US 2006/0113034 A1
(43) Pub. Date: Jun. 1, 2006

(54) Electrochemical cell architecture and method of making same via controlled powder morphology

(76) Inventors: Matthew M. Seabaugh, Columbus, OH (US); Edward M. Sabolsky, Westerville, OH (US); Katarzyna Sabolsky, Westerville, OH (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/261,932

(22) Filed: Oct. 31, 2005

Related U.S. Application Data
(60) Provisional application No. 60/622,794, filed on Oct. 29, 2004.

(51) Int. Cl. B32B 3/00; B32B 15/04; B32B 9/00

(52) U.S. Cl. 156/308.2; 428/312.6; 428/469; 428/701; 428/702

(57) ABSTRACT

The embodiments relate to an electrochemical cell that includes a first layer including a porous ceramic layer having pore channels. The pore channels can be infiltrated with a conductive coating, and can be sufficiently large that a majority of the pore channels remain open after applying the conductive coating. The cell can include a second layer on the first layer, the second layer including a porous interlayer. The first and second layer can function as an anode or a cathode. The cell can include a third layer including a ceramic membrane, and a cathode positioned on the third layer. The embodiments also relate to a method of making an electrochemical cell.

### BACKGROUND

1. Field of the Invention

Embodiments relate generally to electrochemical cells and to methods of their preparation. More specifically, the embodiments relate to ceramic electrochemical cells having a supported thin film architecture. The support structure preferably has a microstructure well suited for the subsequent deposition of electrochemically active species that can produce a cell having enhanced chemical or electrical transport to the membrane. Embodiments have broad applicability in electrochemical separations or catalytic reactors including, but not limited to, solid oxide fuel cells and oxygen separation membranes.

2. Description of Related Art

The preparation of solid state electrochemical cells is known. For example, a typical solid oxide fuel cell (SOFC) includes a dense electrolyte membrane that is a ceramic which is an oxygen ion conductor and electrically non-conductive, a porous anode layer of a ceramic, a metal or, most commonly, a ceramic-metal composite (“cermet”) on the fuel side of the cell that is in contact with the electrolyte membrane, and a porous cathode layer that can be comprised of a mixed ionically/electronically-conductive (MIEC) metal oxide on the oxidant side of the cell. Electricity is generated through the electrochemical reaction between a fuel and an oxidant (typically air). The net electrochemical reaction involves charge transfer steps that occur at the interface between the ionically-conductive electrolyte membrane and the electronically-conductive electrode.

The electrolyte of a typical SOFC is made primarily from solid ceramic materials that are capable of surviving the high temperature environment typically encountered during operation of solid oxide fuel cells. An operating temperature of greater than about 600° C. allows internal reforming, promotes rapid kinetics with non-precious materials, and produces high quality by-product heat for cogeneration or for use in a bottoming cycle. The high temperature of the solid oxide fuel cell, however, places stringent requirements on its fabrication materials. Because of the high operating temperatures of conventional solid oxide fuel cells (approximately 600 to 1000° C.), the materials used to fabricate the respective cell components are generally limited by chemical stability in oxidizing and reducing environments, chemical stability of contacting materials, conductivity, and thermomechanical compatibility.

The most common anode materials for solid oxide fuel cells are nickel (Ni)-cermets prepared by high-temperature calcination of NiO and yttria-stabilized zirconia (YSZ) powders. High-temperature calcination usually is desired in order to obtain a desired ionic conductivity in the YSZ. The Ni-cermets perform well for hydrogen (H₂) fuels and allow internal steam reforming of hydrocarbons if there is sufficient water in the feed to the anode. Because Ni catalyzes the formation of graphite fibers in dry methane, however, it is necessary to operate anodes made using nickel at steam/methane ratios greater than one.

Because Ni is known to catalyze the formation of graphite and require steam reformation, some anodes have been prepared that do not require such high steam/carbon ratios. Different types of anodes have been used, for example, based on doped ceria (see K. Eguchi et al., Solid State Ionics, 52, 165 (1992); G. Mogensen, Journal of the Electrochemical Society, 141, 2122 (1994); and E. S. Putna et al., Langmuir, 11, 4832 (1995)), perovskite (see R. T. Baker et al., Solid State Ionics, 72, 328 (1994); K. Asano et al., Journal of the Electrochemical Society, 142, 3241 (1995); and Y. Hiei et al., Solid State Ionics, 1267, 86-88 (1996)), LaCrO₃ and SrTiO₃ (see R. Doshi et al., J. Catal. 140, 557 (1993); J. Sfeir et al., J. Eur. Ceram. Cos., 19, 897 (1999); M. Weston et al., Solid State Ionics, 247, 113-115, (1998); and J. Liu et al., Electrochem. & Solid-State Lett., 5, A122 (2002)), and copper (see U.S. Pat. Nos. 6,939,637, and 6,811,904), the disclosures of which are incorporated by reference herein in their entirety. Other metals, including Co (N. M. Sammnes et al., Journal of Materials Science, 31, 6060 (1996)), Fe (C. H. Bartholomew, Catalysis Review-Scientific Engineering, 24, 67 (1982)), Ag or Mn (T. Kawada et al., Solid State Ionics, 418, 53-56, (1992)) also have been considered.

As a result of the catalytic properties of various electronic conductors that can be used in the anode, Cu-based anodes have been developed for use in solid oxide fuel cells. See, for example, S. Park, et al., Nature, 404, 265 (2000); R. J. Gorte et al., Adv. Materials, 12, 1465 (2000); S. Park et al., J. Electrochem. Soc., 146, 3603 (1999); S. Park et al., J. Electrochem. Soc., 148, A443 (2001); and H. Kim, et al., J. Am. Ceram. Soc., 85, 1473 (2002). Compared to Ni, Cu is not catalytically active for the formation of C—C bonds. Its melting temperature (1083° C.) is low compared to that of Ni (1453° C.). However, for low-temperature operation, e.g., less than 800° C., Cu is sufficiently stable.

Because Cu₂O and CuO melt at 1235° C. and 1326° C. respectively, temperatures below that necessary for densification of YSZ electrolytes, it is not possible to prepare Cu-YSZ cermets by high-temperature calcination of mixed powders of CuO and YSZ, a method analogous to that usually used as the first step to produce Ni-YSZ cermets. An alternative method for preparation of Cu-YSZ cermets was therefore developed in which a porous YSZ matrix was prepared first, followed by addition of Cu and an oxidation catalyst in subsequent processing steps See, for example, R. J. Gorte et al., Adv. Materials, 12, 1465 (2000); S. Park et al., J. Electrochem. Soc., 148, A443 (2001). Because the Cu phase in the final cermet should typically be highly connected, high metal loadings are generally necessary. High metal loadings may be necessary in an attempt to try and get the required connectivity in the Cu phase. Such high loadings, however, may lead to pores becoming blocked thereby limiting gas flow within the anode. However, simply increasing the pore size in an effort to stop pore blocking leads to a decrease in cell activity. It is believed that this decrease is result of reduced area of triple phase boundary due to the larger pore and particle size at the anode/electrolyte interface.

Various techniques have been used to prepare supported thin films of ceramic membranes, e.g., electrolytes, anodes, and cathodes for SOFCs, including chemical and electrochemical vapor deposition, sol-gel coating methods, spray and dip coating of particulate slurries, calendaring of multilayer samples, and screen printing. Another process for preparing SOFC electrolytes and electrodes is tape casting, in which porous-dense bi-layers are fabricated by the lamination of pre-ceramic sheets containing the particular oxide powders, polymeric binders that provide plasticity to the tape, and a pyrolyzable fugitive phase that is incorporated into the support layers to prevent densification. Conventional tape casting methods with fully stabilized sub-micron YSZ particles are described in some of the above-mentioned documents. Porous YSZ matrices made by conventional tape casting techniques may, however, sometimes be limited in size due to the lack of strength of the resulting layer.

In SOFCs that have components that are sensitive to high temperature (i.e., catalysts, electrical conductors, etc.), such temperature sensitive elements can be added after the porous matrix is heated for sinterering. It is desirable for such solid oxide fuel cells to be fabricated from electrode support structures that are highly porous and have a high pore volume after heat treatment so that the catalyst and other additives can be deposited in the structure without closing off pore channels. It also is desirable that the porosity be highly interconnected and large in diameter (preferably larger >5 um) to allow sufficient gas transport after the catalyst infiltration. In addition, the support structure should be strong enough to allow the handling and drying stresses associated with any processing that may occur after the porous matrix is fabricated as well as thermal and mechanical stresses that occur during operation. Furthermore, it is highly desirable to have a flexible manufacturing method so that electrodes consisting of different layers with different characteristics including strength and porosity may be manufactured.

The description herein of certain advantages and disadvantages of various features, embodiments, methods, and apparatus disclosed in other publications is not intended to limit the scope of the present embodiments. Indeed, the preferred embodiments may include some or all of the features, embodiments, methods, and apparatus described above without suffering from the same disadvantages.

### SUMMARY OF THE INVENTION

It typically is advantageous for a fuel cell to have the characteristics of efficient electrochemical oxidation, low resistance, and high power density. Exemplary embodiments provide these and other advantages while overcoming the deficiencies of known electrochemical cells.

It would be desirable to provide a solid oxide fuel cell that has high fuel efficiency, high electrical conductivity, high power density, and that is capable of directly oxidizing hydrocarbons. It would also be desirable to provide porous support materials useful in forming anode and cathode materials, as well as methods of preparing the porous support materials for use in fuel cells. A feature of one embodiment is to provide a solid oxide fuel cell that has high fuel efficiency, electrical conductivity, high power and power density, and is capable of directly oxidizing hydrocarbons, as well as providing porous support materials, anode and cathode materials, methods of making the porous support materials, anode and cathode materials, and methods of making solid oxide fuel cells.

One embodiment relates to an article comprising: a first layer comprising a porous ceramic layer having pore channels, wherein the pore channels are at least partially covered with a conductive coating in such a manner that the first layer pore channels are sufficiently large that a majority of the pore channels remain open after applying the conductive coating; a second layer positioned on the first layer, whereby the second layer includes a porous interlayer in which the pores are significantly smaller than the first layer pore channels, but still remain open after applying the conductive coating; a third layer comprising a ceramic membrane; and a cathode positioned on the third layer.

In this embodiment, the first and second layers together act as the anode and the third layer is the electrolyte. Furthermore, the first layer primarily acts to disperse the fuel evenly throughout the anode and conduct electrons to the anode surface for collection. The second layer is designed to increase the active catalytic area of the cell, increasing the number of sites where fuel can be oxidized. This active second layer should be close (i.e., on the order of 15 um) to the electrode, or third layer. This embodiment also encompasses the first and second layers together acting as a cathode, the third layer being the electrolyte, and additional layer(s) comprising that anode. The cathode and anode both can be made in accordance with this embodiment, or only one of the electrodes could be made in accordance with this embodiment.

Another embodiment relates to a method of making an article, the method comprising: forming a first layer made from a first powder having particles of a first size and pore formers of a first size and quantity; forming a second layer made from a second powder having particles of a second size and pore formers of a second size and quantity; forming a third layer made from a third powder having particles of a third sizelaminating the first, second and third layers together; heating the first, second and third layers to remove the pore formers; sintering the first, second and third layers; applying a coating to the first and second layers; and optionally forming a cathode on the third layer. The coating is capable of providing conductive, catalytic or other properties to the porous layers. The relative sizes of the particles in each of the three layers as well as the sizes and quantities of pore formers in the first two layers can all be varied to obtain the desired structure. Generally, the particle size and pore formers are larger for the first layer than that of the second and third. The second and third layer can be made with powders of the same particle size.

This embodiment also encompasses making a cathode and electrolyte using the first, second, and third layers described above, and then optionally forming an anode on the third layer. Alternatively, the cathode and anode can be prepared using the same technique described above, in which case, the resulting structure would be comprised of 5 or more layers (the anode comprising 2 layers, the electrolyte comprising one layer, and the cathode comprising 2 layers).

The sintered first layer comprises pore channels that are sufficiently large that a majority of the pore channels remain open after applying the coating. The sintered second layer may comprise a porous interlayer with multiple active sites for oxidizing the fuel, when the second layer is used in an anode. The sintered third layer comprises a ceramic electrolyte membrane. A similar process could be used to make electrodes with more than 2 layers that are laminated to an additional layer which is the electrolyte (or ceramic membrane).

### BRIEF DESCRIPTION OF THE DRAWINGS

FIG. 1 is a drawing of a structure for an electrochemical cell according to an exemplary embodiment;

FIG. 2a is a diagram showing a mixture of oxide aggregates and fine scale fugitive material in which the amount of fugitive material is sufficient to fill the voids between the aggregate particles;

FIG. 2b is a diagram showing a mixture of aggregates and fine scale fugitive material in which the amount of fugitive material has been increased beyond that necessary to fill the voids between the aggregate particles;

FIG. 2c is a diagram showing the formation of a sintered article in which the fugitive material has been pyrolyzed;

FIG. 2d is a diagram showing a mixture of oxide aggregates and fugitive material in which the size of the fugitive material particles is roughly equal to the size of oxide aggregate particles;

FIG. 2e is a diagram showing the article of FIG. 2d after it has been sintered;

FIG. 3 is a scanning electron micrograph (SEM) of the calcined PSZ powder of Example 1 described below;

FIG. 4 is an scanning electron micrograph of the sintered sample of Example 2 described below;

FIG. 5 is an SEM of the sintered sample of Example 3a described below;

FIG. 6 is an SEM of a milled, fully-stabilized zirconia powder used for the interlayer and electrolyte layer of Example 4 described below;

FIG. 7 is an SEM of the sintered sample of Example 4;

FIG. 8 is a graph showing cell potential and power density as a function of current density for a known cell (triangles) and two cells (circles and squares) according to an embodiment exposed to flowing hydrogen gas;

FIG. 9 is a graph showing cell potential and power density as a function of current density for a known cell (triangles) and two cells (circles and squares) according to an embodiment exposed to flowing butane;

FIG. 10 is a graph showing cell potential and power density as a function of current density for a known cell (triangles) and two cells (circles and squares) according to an embodiment exposed to flowing hydrogen gas;

FIG. 11 is an electronic impedance spectroscopy spectra for a known cell (triangles) and two cells (circles and squares) according to an embodiment exposed to butane;

FIG. 12 is an electronic impedance spectroscopy spectra for a known cell (triangles) and two cells (circles and squares) according to an embodiment exposed to hydrogen; and

FIG. 13 is a table showing, among other things, the power density for a known cell as compared with the power density of two cells according to an embodiment described herein.

### DETAILED DESCRIPTION OF THE PREFERRED EMBODIMENTS

The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a solid oxide fuel cell” includes a plurality of such fuel cells in a stack, as well as a single cell, and a reference to “an anode” is a reference to one or more anodes and equivalents thereof known to those skilled in the art, and so forth.

Unless defined otherwise, all technical and scientific terms used herein have the same meanings as commonly understood by one of ordinary skill in the art to which this invention pertains. Although any methods and materials similar or equivalent to those described herein can be used in the practice or testing of the present invention, the preferred methods, devices, and materials are now described. All publications mentioned herein are cited for the purpose of describing and disclosing the various anodes, electrolytes, cathodes, and other fuel cell components that are reported in the publications and that might be used in connection with the invention. Nothing herein is to be construed as an admission that the invention is not entitled to antedate such disclosures by virtue of prior invention.

According to an exemplary embodiment, an electrochemical cell, such as a SOFC, comprises an air electrode (cathode), a fuel electrode (anode), and a solid oxide electrolyte disposed between these two electrodes. In a SOFC, the electrolyte is in solid form. Typically, the electrolyte is made of a nonmetallic ceramic, such as dense yttria-stabilized zirconia (YSZ) ceramic. The dense YSZ is believed to be a nonconductor of electrons, which can ensure that the electrons pass through the external circuit to do useful work. As such, the electrolyte provides a voltage buildup on opposite sides of the electrolyte while isolating the fuel and oxidant gases from each other. The anode and cathode are typically porous. Hydrogen or a hydrocarbon is commonly used as the fuel, and oxygen or air is used as the oxidant.

The embodiments of SOFCs can include a solid electrolyte made using techniques disclosed in the art. The embodiments are not particularly limited to any particular material used for the electrolyte or its method of manufacture.

U.S. Pat. Nos. 5,273,837; 5,089,455; and 5,190,834, the disclosures of which are incorporated by reference herein in their entirety, disclose additional designs that may be used in conjunction with exemplary embodiments. Embodiments may also include various designs or configurations. For example, several different designs of solid oxide fuel cells have been developed, including the tubular design, the segmented design, the monolithic design, and the flat plate design. These designs are described, for example, in Minh, “High-Temperature Fuel Cells Part 2: The Solid Oxide Cell,” Chemtech., 21:120-126 (1991). Using the description provided herein, those skilled in the art will be capable of fabricating an electrochemical cell such as an SOFC having the desired design configuration.

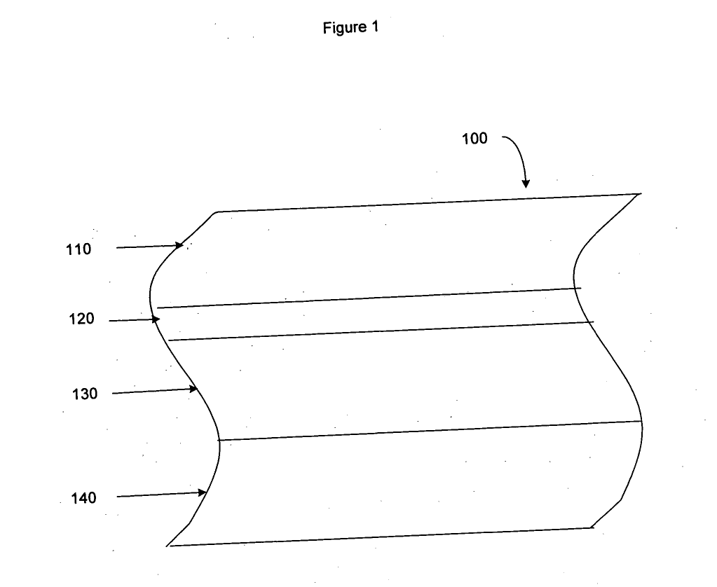

FIG. 1 depicts an example of an article forming part of a fuel cell according to one embodiment of the invention. The article 100 comprises a porous support structure 110 that supports an anode, a solid electrolyte 130, an interlayer 120 between the porous layer 110 and the electrolyte 130, and a cathode 140 positioned on the electrolyte. The thicknesses of the respective layers illustrated in FIG. 1 are exemplary only, and shown merely for the purpose of illustration. Skilled artisans will appreciate that the respective layers can have a variety of thicknesses, all of which are within the scope of the embodiments described herein. In addition, the arrangement of electrodes illustrated in FIG. 1 is exemplary only, and the cathode 140 may be comprised of a porous structure and interlayer in the same or similar manner as the anode. Alternatively, porous support structure 110 and interlayer 120 may comprise a cathode, and layer 140 may comprise an anode. Skilled artisans will be capable of making an anode or cathode comprising a porous support structure 110 and interlayer 120, using the guidelines provided herein.

Throughout this description, the term “on” or “positioned on” denotes that the respective items are superposed upon one another, but does not mean that the respective items must be immediately adjacent. Rather, other items may be positioned between the respective items, as will be appreciated by those skilled in the art. The article 100 shown in FIG. 1 can be used in fuel cells of various configurations as described above. The embodiments relate to the structure 100 shown in FIG. 1 and to methods for making an electrochemical cell including the structure 100.

According to a preferred embodiment, the electrolyte 130 comprises a dense ceramic membrane, the interlayer 120 comprises a highly porous, finely divided layer, and the porous support structure 110 comprises a highly porous, coarsely divided layer that supports an anode in a fuel cell. The porous support structure 110 is preferably designed to facilitate gas flow to the finely divided interlayer 120. The finely divided interlayer 120 is adapted to diffuse the reactants over a large surface area, providing numerous electrochemically active sites and enhancing the kinetics at the fuel/ionconductor/electron conductor interface.

The electrolyte 130 preferably is a nonconductor of electrons, which ensures that the electrons must pass through the external circuit to do useful work. The electrolyte 130 provides a voltage buildup on opposite sides of the electrolyte 130, while isolating the fuel and oxidant gases from each other. An additional support layer on top of porous support structure 110 may be desirable in some embodiments. Such a support structure could be made out of dense YSZ with large perforations to facilitate gas flow to the underlying layers. This layer can be incorporated into the anode design for structural support, the layer could be comprised of ceramics and/or metals. It may be desirable for this support layer to be electronically conductive.

The porous support structure 110, according to an exemplary embodiment, is adapted to provide support to the anode. The reactive layer of the anode may be formed by dispersing a catalytic phase and/or electron conductive phase in the microstructure of the porous support structure 110 and/or the interlayer 120 to form a porous anode. The catalyst may perform a number of functions, such as the reformation of fuels, preferential oxidation of a feedstock, or electron transport for electrochemical reactions. Because the catalytic materials often are precious metals and more expensive than the porous support structure 110 or the interlayer 120 structure, the amount of the catalytic material typically is minimized by adding it to the surface of the pores. The catalytic species may be chemically or mechanically incompatible with the porous support structure 110 and/or the interlayer 120 and/or the material of the electrolyte 130 at the fabrication temperature of these components. For example, a copper catalyst melts below the sintering temperature of stabilized zirconia. Consequently, the catalyst should be added to the porous support structure 110 and/or interlayer after the porous support structure 110 and interlayer 120 have been sintered at a high temperature. Catalysts, such as copper and ceria, can be added to both layers, 110 and 120. It is preferable to have a conducting material such as copper deposited in a mostly continuous fashion throughout both layers to facilitate electronic conduction from the active sites in the porous layers 110 and 120 to the outer surface of the perforated layer (e.g., either porous anode layer 110 or an additional layer).

It is typically desirable that the porous support structure 110 retain a high pore volume after heat treatment so that the catalyst can be deposited in the porous support structure 110 and 120 without closing off pore channels therein. The porosity of the porous support structure 110 is preferably highly interconnected and large in diameter to allow sufficient gas transport after the catalyst infiltration. The porous support structure 110 and interlayer 120 also are preferably designed to be strong enough to withstand the handling and drying stresses associated with the catalyst deposition process.

The porous support structure 110 typically is prepared from ceramic powders specifically designed to provide large interconnected pores with low tortuosity, yet the powder sinters at temperatures below about 1400° C. The powder for the porous support structure preferably has a particle size of from about 20 to about 100 microns (μm), and when sintered, the resulting structure has desirable mechanical strength while preserving a large volume of accessible pores. Preferably, the resulting sintered structure has a porosity within the range of from about 30 to about 75 vol. %. Thus, the shrinkage of the materials during sintering is limited, e.g., less than 20% linear shrinkage, to prevent the warpage of the structure 100. Materials that are useful for forming the porous support structure 110 include, for example, partially stabilized yttrium stabilized zirconia (PSZ, i.e., 3 mol % yttrium doping in zirconia), yttrium stabilized zirconia, Gc- and Sm-doped ceria (10 to 100 wt %), Sc-doped ZrO₂ (up to 100 wt %), and doped LaGaMnOₓ and other ionically conductive ceramics

The interlayer 120 preferably is positioned between the porous support structure 110 and the electrolyte 130, although other layers may be positioned between these layers. The interlayer 120, according to an exemplary embodiment, comprises a highly porous, finely divided structure. Layer 120 may be made out of any ionically conductive ceramic. In a preferred embodiment, the interlayer is made out of the same ceramic material as the electrolyte 130, typically comprised of yttria stabilized zirconia (YSZ i.e., 8 mol % yttrium doped zirconia). The interlayer could be made out of Scandia doped zirconia (ScZr), GdC or any other material that is used for electrolyte and compatible with the manufacturing process. The interlayer 120 serves to diffuse the reactants over a large surface area, providing numerous electrochemically active sites and enhancing the kinetics at the interface with the electrolyte 130. The interlayer 120 can increase the reactivity of copper-ceria catalyzed cell reactions, for example, by increasing the reactive interfacial area at the electrode/electrolyte interface.

The interlayer 120 can be fabricated using a sub-micron fully stabilized zirconia powder. The powder may be incorporated into a tape casting slurry with a fine scale fugitive powder, such as rice starch, graphite, or other pyrolyzable compounds, and cast into tapes. The tapes may have a thickness of 50 microns, for example, or other suitable thickness. One or more strips may be placed on top of the similar tapes that will form the porous support structure 110.

The powders used to make the support layer are preferably about 20-70 microns in diameter but coarser powders up to about 100 microns could be used. Preferably the powders are partially stabilized zirconia for their strength characteristics. The interlayer structure preferably is fabricated using a sub-micron fully stabilized zirconia powder.

The electrolyte 130, according to an exemplary embodiment, comprises a solid, nonmetallic ceramic, such as a dense yttria-stabilized zirconia (YSZ) ceramic. Other useful materials for the electrolyte 130 include Sc-doped ZrO₂, Gd- and Sm-doped CeO₂, and LaGaMnOx. The electrolyte 130 provides a voltage buildup on opposite sides of the electrolyte 130 while isolating the fuel and oxidant gases from each other.

The cathode 140 may comprise doped lanthanum manganite, for example, or other materials such as composites with Sr-doped LaMnO₃, LaFeO₃, and LaCoO₃, or metals such as Ag, or any other materials that are used for making cathodes (e.g., any ceramic material that provides ionic conductivity with additional components that are useful in the reduction of oxygen). In one embodiment, the electrolyte is flash coated with Gd doped CeO₂ before the application of the cathode. This additional layer is believed to limit solid state reactions between the electrolyte and the cathode.

The cathode 140 can be formed by applying the cathode composition, e.g., a mixture of YSZ and La_{0.8}Sr_{0.2}MnO₃, as a paste onto the electrolyte 130 and then calcining the cathode 140 at a temperature within the range of from about 1,000 to about 1,300° C., more preferably within the range of from about 1,100 to about 1,200° C., and most preferably about 1,130° C. Alternatively, the cathode 140 can be formed by forming a porous support structure 110 and interlayer 120 as described above, and then applying a suitable cathode catalytic material to the porous structures, as described above. Methods of forming porous cathode materials by impregnating a porous ceramic material with precursors to an electronically conducting material (i.e., cathode catalytic material) are disclosed in, for example, U.S. Pat. No. 6,958,196, the disclosure of which is incorporated by reference herein in its entirety.

Methods of making exemplary embodiments will now be described. According to one exemplary method, the ceramic powders used to form the porous support structure 110 are tailored to achieve the desired microstructure by a calcination process. The calcination process can reduce the surface area of the powder, eliminate fine scale porosity within the aggregates (groups of particles that adhere together) and maintain sufficient surface energy in the aggregates to allow densification. The calcination process can be carried out on conventional powders. For example, the calcination process could consist of heating the powder in batches to 1000° C. or higher for 8 hours or more.

According to preferred embodiments, the open structure of the ceramic aggregates limits shrinkage of the porous support structure 110. The aggregated powders used in preferred embodiments typically are not capable of closing the large pore channels established during green forming. The uniformity of the aggregate size and the size distribution can also be advantageous in achieving the desired microstructure

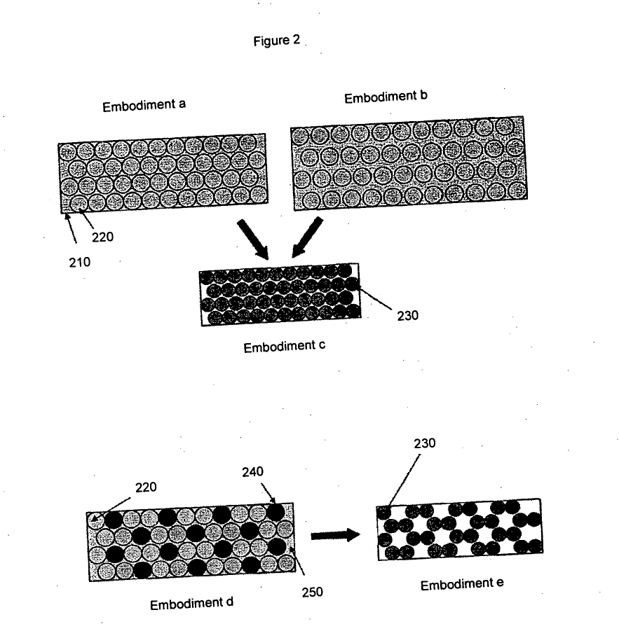

If desired, the porosity of one or more layers of the cell architecture, such as the porous support structure 110, can be increased in various embodiments of the invention by addition of pore formers and fugitives. The fugitives can be fine-scale fugitives or they can be coarse particle size fugitive material whereby the particle size of the ceramic powder and the fugitive material are about the same order of magnitude. Such embodiments are illustrated in FIGS. 2a-2e. The effect of the use of a fine fugitive material, such as rice starch, on the porosity development is shown in FIG. 2a. As shown in FIG. 2a, the initial additions of fine scale pore formers simply fills the void space that exists between the oxide aggregates. As the amount of fugitive exceeds the volume of the void space, the aggregates will be pushed apart until a continuum of fugitive material serves to separate the particles. This feature is shown in FIG. 2b. Upon sintering at the appropriate temperature, the structure should collapse back to a level of packing similar to that achieved with lower fugitive contents, as shown in FIG. 2c.

If a larger fugitive material were used alone or in combination with finer fugitive material, however, the particle network should be displaced to create very large voids in the structure that remain open even after the binder is burned out, by virtue of the structural integrity of the interparticle network. This can be seen in FIG. 2d, where coarse fugitive particles 240 are used, and when sintered, the porosity is much greater, as shown in FIG. 2e. As seen in FIG. 2e, sintering of the structure should not cause collapse of the structure, as the particles 230 are too large to move easily into the void left by the fugitive 240, and the shrinkage of the layer preferably is insufficient to develop stresses that would encourage rearrangement. Preferably, the porous structures of exemplary embodiments of the invention shrink by less than 20% (linear shrinkage), more preferably, less than 18%, and most preferably less than about 15%.

One embodiment encompasses a method of making a porous support structure 110 with an interlayer 120 and a dense ceramic electrolyte 130 for use in an electrochemical cell. In a preferred process, the porous support structure 110 is prepared using a spray dried partially stabilized zirconia (PSZ) powder calcined at a temperature within the range of from about 800 to about 1,200° C., preferably at about 1000° C. to form ceramic aggregates having a particle size (i.e., average particle diameter) preferably in the range of from about 20 to about 100 μm more preferably 20-70 μm. The calcined powder then is incorporated into a tape casting slurry and cast into a tape, e.g. having a thickness of 150 microns. The tape preferably is cut into strips, and stacked, e.g., 4-5 layers thick

The interlayer 120 preferably is prepared with yttrium-stabilized zirconia (YSZ). The interlayer 120 may be fabricated using a sub-micron fully stabilized zirconia powder, for example. The powder may be incorporated into a tape casting slurry with a fine scale fugitive powder such as rice starch, graphite, or other pyrolyzable compound, and cast into tapes having a thickness of 150 microns, for example. The tape can be cut into sheets. One or more sheets of interlayer tape can be placed on top of the stack of PSZ tapes (porous support structure 110).

The dense ceramic electrolyte 130 can be prepared by utilizing a sub-micron fine powder fully stabilized zirconia (YSZ) that is incorporated into a tape casting slurry and cast into tapes having a thickness of 50 microns. The tape preferably is cut into strips. Two sheets of the YSZ tape for the electrolyte 130 preferably can be placed on top of the stack of interlayer 120 and PSZ 110 tapes.

The resulting YSZ/interlayer/PSZ stack can be laminated in an isostatic laminator and then cut into circles using a stainless steel punch. The laminated tri-layer sample can then be placed in a furnace and heated to 1000° C. to burn out the binder. After the binder burnout, the samples can be sintered, for example at 1350° C. for 2 hours. The sintered samples may be returned to the sintering furnace for forging to eliminate sample curvature, and then optionally flattened under 100 g load or other appropriate load at an elevated temperature.

After formation of the porous support structure 110, interlayer 120, and dense electrolyte 130, the electrode (anode or cathode) can be formed by impregnating the porous support structure 110 with an electrode material such as cerium and/or copper nitrate salts, or other metal or conductive material salts (e.g., salts of Sr-doped LaMnO₃, LaFeO₃, L:aCoO₃, Ag, etc.) as desired. The salts can be heated to decompose the nitrates and leave the desired oxide phases. The electrode typically comprises a catalytic electronically conductive material.

In addition, or alternatively, the porous support structure 110 can be impregnated with a second material that can serve as an electrode catalyst, and subsequently sintered, when the electrode is a cathode and/or an anode. Preferred catalytic metals for use in forming an anode include, but are not limited to Ni, Cu, Co, Fe, Ag, Mn, Pd, Pt, and Ce, more preferably, Ni, Ce, and Cu, and most preferably Cu. The catalytic metals can be incorporated into the porous support structure 110 while in its green state and prior to sintering, or impregnated after sintering by immersion in a solution or slurry containing the appropriate metal, or combination of metals. The typical wt % of the electronic conductor is from about 20-30% (i.e., Ni, Cu) and the typical wt % of the optional oxidation catalyst is from about 10-20%.

The anode or cathode may be formed by impregnating the porous support structure 110 of the wafer with an aqueous solution containing an electronically conductive material, such as a catalytic metal, and/or a second ceramic material, or precursor thereof. For example, the YSZ porous support structure 110 can be impregnated with an aqueous solution containing the appropriate salts of Ni or Cu, and/or impregnated with an aqueous solution containing the appropriate concentrations of the nitrate salts of La, Sr, and Cr (for LSC). Salts useful for forming the porous anode include, for example, saturated, aqueous solutions of La(NO₃)₃ and Sr(NO₃)₃. The impregnated porous support structure 110 then preferably is calcined at a temperature sufficient to decompose the nitrate ions and form the conductive, perovskite phase. The anode may also be formed by using other deposition techniques such as electrodeposition, electroless deposition, and CVD.

The porosity of the porous support structure 110 preferably is within the range of from about 25% to about 90%, more preferably within the range of from about 35% to about 80% and most preferably from about 35% to about 70%, by water-uptake measurements, see H. Kim, H et al., J. Am. Ceram. Soc., 85, 1473 (2002). Sintering the three-layer tape in this manner results in a YSZ wafer having a dense electrolyte 130 approximately 40 to about 80 μm thick and more preferably about 60 μm thick, supported by an interlayer 120 having a thickness of approximately 50 microns and a porous support structure 110 approximately 400 to about 800 μm thick, and more preferably about 600 μm thick.

The cathode 140 may comprise, for example, doped lanthanum manganite, Sr-doped LaMnO₃, LaFeO₃, and LaCoO₃, or metals such as Ag. The cathode 140 can be formed by applying the cathode composition, e.g., a mixture of YSZ and Sr-doped LaMnO₃ as a paste onto the electrolyte 130 and then calcining the cathode 140 at a temperature within the range of from about 1,000 to about 1,300° C. Alternatively, the cathode 140 may be made using the technique described above for forming the porous support structure 110 and interlayer 120.

The electrode and process for manufacturing such an electrode set forth in the embodiments described herein also can be used to make a cathode. When the porous support structure 110 is used to form a cathode, a second ceramic material may be impregnated into the porous support structure 110, in addition to the catalytic metal, or alternatively to the catalytic metal. Skilled artisans will appreciate that porous support structure 110 will be placed on the opposite side of the electrolyte from the anode, as shown by numeral 140 in FIG. 1.

Preferred second ceramic materials for use in the embodiments include, but are not limited to ceria, doped ceria such as Gd or Sm-doped ceria, LaCrO₃, SrTiO₃, Y-doped SrTiO₃, Sr-doped LaCrO₃, (LSC), tungsten carbide (WC), and mixtures thereof. When formulated into the anode together with porous YSZ, the second ceramic material LSC may has the formula La_{0.7}Sr_{0.3}CrO_{3-δ}/YSZ. Other formulas are possible, such as La_{0.8}Sr_{0.2}MnO_{3-δ}/YSZ, La_{0.8}Sr_{0.2}FeO_{3-δ}/YSZ, and La_{0.8}Sr_{0.2}CoO_{3-δ}/YSZ. LaFeO3 is a well defined compound, and in the Sr-doped material, it is possible to substitute some of the La(+3) ions with Sr(+2) ions. Thus, it is possible that delta is equal to about 0.1 based on charge balance, although the material, in usage, is probably somewhat reduced, meaning delta is often somewhat larger. It is understood that the embodiments are not limited to these particular ceramic materials, and that other ceramic materials may be used in the anode alone or together with the aforementioned ceramic materials.

It is preferred that the pore size in the support structure is on the order of greater than about 5 um. The porous support structure 110 preferably have a porous structure with a plurality of pores having a pore size greater than about 5 μm. Not all the pores need to have a pore size greater than about 5 μm, but it is preferred that more than 50%, preferably more than 60% and most preferably more than 75% of the pores have a pore size greater than about 5 μm.

Exemplary embodiments now will be explained with reference to the following non-limiting examples. Examples 1-3 relate to formation of a bi-layer structure including the dense ceramic membrane 130 and the porous support structure 110. Examples 4-6 illustrate formation of the dense ceramic membrane 130 and the porous support structure 110 with an interlayer 120 disposed between them.

### EXAMPLE 1

### Preparation of Powders

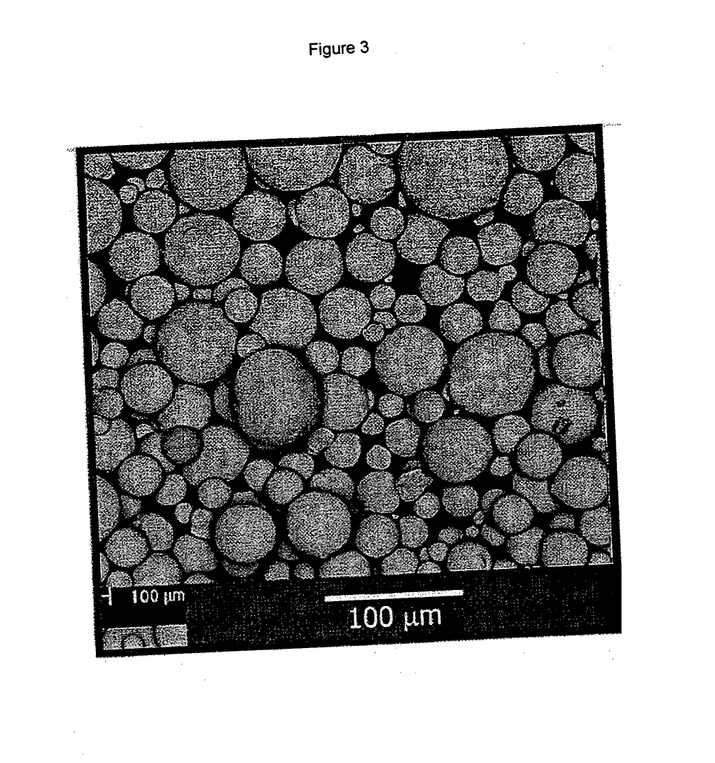

Bi-layer structures were constructed with cast tapes prepared with partially stabilized zirconia (PSZ, Tosoh-TZ-3Y, initial surface area=14.7 m²/g) and yttrium stabilized zirconia (YSZ, Tosoh-TZ-8Y, −surface area=13.0 m²/g). The YSZ powder was used without modification for the electrolyte. The PSZ powder was calcined in 600 g batches at 100° C. for 8 hours, to modify the surface area and ruggedness of the aggregate structure. The calcined powder retained the morphology of the precursor powder, consisting of highly uniform spheres with an average diameter of 20-70 μm. The surface area of the powder was measured to be 11.64 m²/g. The PSZ powder was sieved through a 100 mesh screen and then used to prepare tape casting slurries for the support layers. A scanning electron micrograph (SEM) of the calcined PSZ powder is shown in FIG. 3.

### EXAMPLE 2

### 40 Vol % Fugitive

A tape casting slurry was prepared in 500 ml Nalgene bottles. The bottle was filled with 300 g of media (5 mm diameter, zirconia), 60.99 g of solvent (Ferro, BD75-710), 0.86 g of dispersant (Ferro, M1201), 19.05 g of rice starch (Sigma), and 119.24 g of PSZ powder from Example 1. The bottle was sealed and shaken to mix the ingredients. The bottle was placed on a ball mill for 4 hours. After 4 hours of milling, the bottle was removed and 1.10 g of di(propylene glycol) dibenzoate (Aldrich) and 49.86 g of binder (Ferro, B7400) were added. The bottle was sealed again and replaced on the mill for 12 hours. The milled slurry was decanted into a 250 ml Nalgene bottle and placed on a slow mill for one hour. The slurry was cast onto silicon-coated Mylar. The thickness of the dry tape was 150 microns (μm). The tape was cut into 15×15 cm sheets. The sheets were stacked on top each other, five sheets per stack, and set aside.

The electrolyte tapes of YSZ were prepared using as received Tosoh TZ-8Y. A tape casting slurry was prepared in 500 ml Nalgene bottles. First, the bottle was filled with 300 g of media (5 mm diameter, zirconia), 44.69 g of solvent (Ferro, BD75-710), 0.38 g of dispersant (Ferro, M1201), and 85.40 g of YSZ powder. The bottle was sealed and shaken to mix the ingredients. The bottle was placed on a ball mill for 4 hours. After 4 hours of milling, the bottle was removed and 0.49 g of di(propylene glycol) dibenzoate (Aldrich) and 19.53 g of binder (Ferro, B7400) were added. The bottle was resealed and replaced on the mill for 12 hours. The milled slurry was decanted into a 250 ml Nalgene bottle and placed on a slow mill for one hour. After de-airing, the slurry was cast onto silicon coated Mylar, and allowed to dry for 2 hours. The thickness of the dry tape was 50 μm. The tape was cut into 15×15 cm sheets.

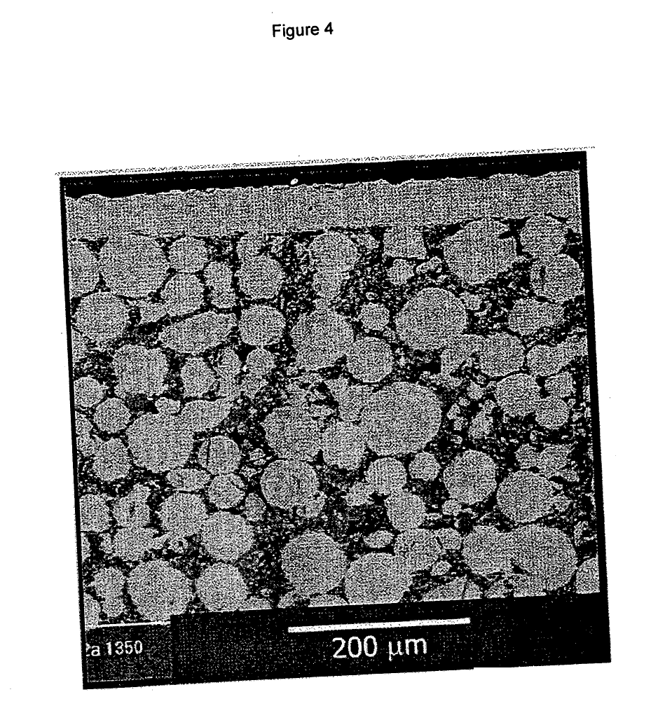

Two sheets of YSZ tape were placed on top of the 5-sheet stack of PSZ tape. The resulting YSZ/PSZ stack was laminated in an isostatic laminator at 80° C. and 96 MPa. The laminate was then taken out and cut into 3.2 cm diameter circles using a stainless steel punch. The circles were placed on porous setters (Seelee, Micromass) with the YSZ layers face-down. The setters with the laminates were then placed in a furnace for binder burnout where the furnace was heated at a temperature of 600° C. After the binder burnout, the samples were placed in a hot temperature oven for sintering. The samples were sintered at 1400° C. for 2 hours. The sintered samples were evaluated by SEM, as shown in FIG. 4. The cells had a support density of 3.59 g/cm³, approximately 60% of theoretical. The sintered samples were then flattened by placing about 100 g load on each sample. The samples were then heated to 1300° C. for 6 hours to produce flat samples.

### EXAMPLE 3A

### 70 Vol % Fugitive

A tape casting slurry was prepared in 250 ml Nalgene bottles. The bottle was filled with 100 g of media (5 mm diameter, zirconia), 29.80 g of solvent (Ferro, BD75-710), 0.42 g of dispersant (Ferro, M1201), 16.29 g of rice starch (Sigma), and 29.13 g of PSZ powder from Example 1. The bottle was sealed and shaken to mix the ingredients. The bottle was placed on a ball mill for 4 hours. After 4 hours of milling, the bottle was removed and 0.54 g of di(propylene glycol) dibenzoate (Aldrich) and 24.36 g of binder (Ferro, B7400) were added. The bottle was sealed again and replaced on the mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The electrolyte tapes of YSZ were prepared using as received Tosoh TZ-8Y. A tape casting slurry was prepared in 500 ml Nalgene bottles. First, the bottle was filled with 300 g of media (5 mm diameter, zirconia), 44.69 g of solvent (Ferro, BD75-710), 0.38 g of dispersant (Ferro, M1201), and 85.40 g of YSZ powder. The bottle was sealed and shaken to mix the ingredients. The bottle was placed on a ball mill for 4 hours. After 4 hours of milling, the bottle was removed and 0.49 g of di(propylene glycol) dibenzoate (Aldrich) and 19.53 g of binder (Ferro, B7400) were added. The bottle was resealed and replaced on the mill for 12 hours. The milled slurry was decanted into a 250 ml Nalgene bottle and placed on a slow mill for one hour. After de-airing, the slurry was cast onto silicon coated Mylar, and allowed to dry for 2 hours. The thickness of the dry tape was 50 μm. The tape was cut into 7×7 cm sheets.

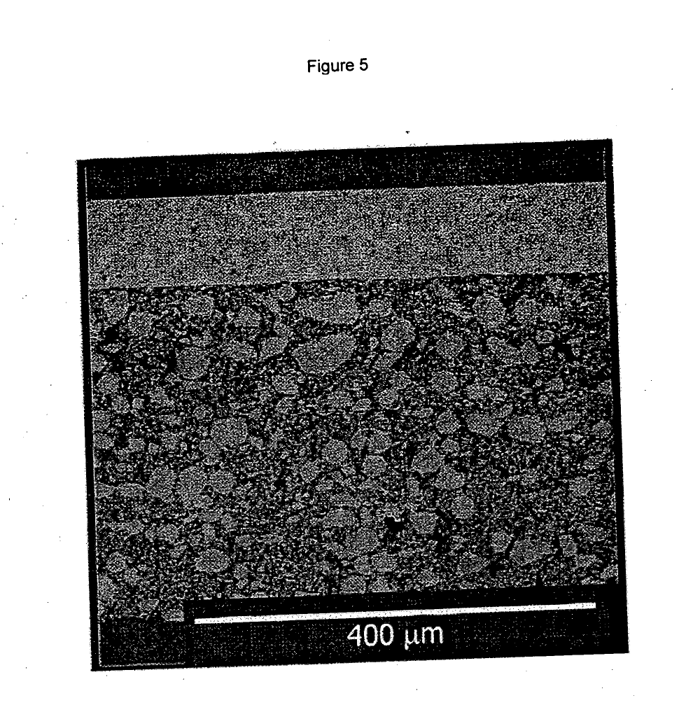

Two sheets of YSZ tape were placed on top of the 5-sheet stack of PSZ tape. The resulting YSZ/PSZ stack was laminated in an isostatic laminator at 80° C. and 96 MPa. The laminate was then taken out and cut into 3.2 cm diameter circles using a stainless steel punch. The circles were placed on porous setters (Seelee, Micromass) with the YSZ layers face-down. The setters with the laminates were then placed in a furnace for binder burnout to 600° C. After the binder burnout, the samples were placed in a hot temperature oven for sintering. The samples were sintered at 1400° C. for 2 hours. The sintered samples were evaluated by SEM, as shown in FIG. 5. The cells had a support density of 2.89 g/cm³, approximately 49% of theoretical. The sintered samples were then flattened by placing about 100 g load on each sample. The samples were then heated to 1300° C. for 6 hours to produce flat samples.

### EXAMPLE 3B

### 70 Vol % Fugitive with Extra Binder

A tape casting slurry was prepared in 250 ml Nalgene bottles. The bottle was filled with 100 g of media (5 mm diameter, zirconia), 26.88 g of solvent (Ferro, BD75-710), 0.42 g of dispersant (Ferro, M1201), 16.29 g of rice starch (Sigma), and 29.13 g of PSZ powder from Example 1. The bottle was sealed and shaken to mix the ingredients. The bottle was placed on a ball mill for 4 hours. After 4 hours of milling, the bottle was removed and 0.54 g of di(propylene glycol) dibenzoate (Aldrich) and 27.28 g of binder (Ferro, B7400) were added. The bottle was sealed again and replaced on the mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The electrolyte tapes of YSZ were prepared using as received Tosoh TZ-8Y. A tape casting slurry was prepared in 500 ml Nalgene bottles. First, the bottle was filled with 300 g of media (5 mm diameter, zirconia), 44.69 g of solvent (Ferro, BD75-710), 0.38 g of dispersant (Ferro, M1201), and 85.40 g of YSZ powder. The bottle was sealed and shaken to mix the ingredients. The bottle was placed on a ball mill for 4 hours. After 4 hours of milling, the bottle was removed and 0.49 g of di(propylene glycol) dibenzoate (Aldrich) and 19.53 g of binder (Ferro, B7400) were added. The bottle was resealed and replaced on the mill for 12 hours. The milled slurry was decanted into a 250 ml Nalgene bottle and placed on a slow mill for one hour. After de-airing, the slurry was cast onto silicon coated Mylar, and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then taken out and cut into 3.2 cm diameter circles using a stainless steel punch. The circles were placed on porous setters (Seelee, Micromass) with the YSZ layers face-down. The setters with the laminates were then placed in a furnace for binder burnout to 600° C. After the binder burnout, the samples were placed in a hot temperature oven for sintering. The samples were sintered at 1400° C. for 2 hours. The cells had a support density of 2.93 g/cm³, approximately 50% of theoretical. The sintered samples were then flattened by placing about 100 g load on each sample. The samples were then heated to 1300° C. for 6 hours to produce flat samples.

Examples 2 and 3a and 3b are representative of how to manufacture the porous support with varying amounts of fugitives. The fugitive amounts (and thereby the resulting porosity of the porous support) can be varied widely, and any amount of fugitive can be used in the embodiments. Preferred amounts of fugitives range from about 20 vol % to 90 vol. %, more preferably, from about 40 vol. % to about 80 vol %, including, for example, 40 vol. %, 50 vol %, 60 vol. %, 65 vol. %, and 70 vol. %. Note that in these examples only two layer structures are discussed, but in the manufacture of an embodiment there would be an interlayer in between the porous support layer and the electrolyte.

### EXAMPLE 4

### Multi-layer Support Fabrication Support tapes of PSZ were Prepared as Described Above in Examples 2-3

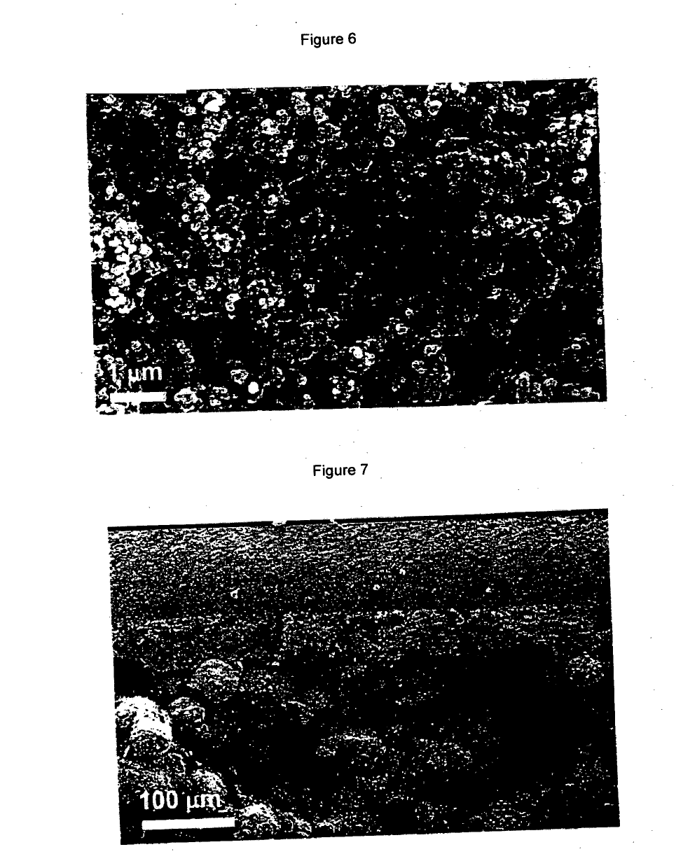

An interlayer was constructed with cast tapes prepared with yttrium-stabilized zirconia (YSZ, Tosoh-TZ-8Y, surface area=13.0 m₂/g). The YSZ powder was used without modification. The yttrium stabilized zirconia powder used is shown in FIG. 6. The interlayer tapes of YSZ were prepared using as received Tosoh TZ-8Y. A tape casting slurry was prepared in 500 ml Nalgene bottles. First the bottle was filled with 300 g of media (5 mm diameter, zirconia), 104.72 g of solvent (Ferro, BD75-710), 0.46 g of dispersant (Ferro, M1201), 109.72 g of YSZ powder, and 49.76 g of rice starch. The bottle was sealed and shaken to mix the ingredients. The bottle was placed on a ball mill for 4 hours. After 4 hours of milling, the bottle was removed and 2.96 g of di(propylene glycol) dibenzoate (Aldrich) and 83.10 g of binder (Ferro, B7400) were added. The bottle was resealed and replaced on the mill for 12 hours. The milled slurry was decanted into a 250 ml Nalgene bottle and placed on a slow mill for one hour. After de-airing, the slurry was cast onto silicon coated Mylar, and allowed to dry for 2 hours. The thickness of the dry tape was 150 μm. The tape was cut into 15×15 cm sheets. A single sheet of interlayer tape was placed on top of 4-sheet stack of PSZ tape.

Electrolyte tapes were prepared as described above in Examples 2-3. Two sheets of YSZ tape were placed on top of the stack of interlayer and PSZ tapes. The resulting YSZ/interlayer/PSZ stack was laminated in an isostatic laminator at 80° C. and 96 MPa. The laminate was then taken out and cut into 3.2 cm diameter circles using a stainless steel punch. The circles were placed on porous setters (Seelee, Micromass) with the YSZ layers face-down. The setters with the laminates were then placed in a furnace for binder burnout to 1000° C. After the binder burnout, the samples were placed in a hot temperature oven for sintering. The samples were sintered at 1350° C. for 2 hours. Examples of the sintered microstructure are shown in FIG. 7.

### EXAMPLE 5

### Fuel Cell Fabrication using Multi-layer Supports

Fuel cell samples were produced using the ceramic multi-layers produced in Example 4 and multilayers produced as described in Example 2-8. A commercial cathode ink (LSF Ink, NexTech Fuel Cell Materials, Lewis Center Ohio) was applied by painting a circle 0.3″ in diameter and subsequently drying and sintering the multi-layers at 1000° C. for 1 hour, to produce a porous layer approximately 50 microns thick.

A 61 wt % aqueous solution of cerium nitrate (Ce(NO₃)₃.6H₂O was added to the porous support side of the cells using a precision repeater pipette in approximately 0.4 ml additions. As the cell absorbed each deposition another addition was made. When the cell was saturated the cell was dried for 10 minutes to allow complete penetration, and excess material blotted from the surface of the support. The cells were then placed in a drying oven at 100° C. for 15 minutes. After drying, the cycle was repeated a second time. After two cycles the cell was sintered by heating it to 450° C. at a 10° C./min rate, and held at temperature for 2 hours. The deposition and sintering cycle was repeated until the targeted cerium oxide addition was achieved (approximately 3-5 wt % cerium oxide).

Following the cerium oxide addition, a 68% aqueous solution of copper nitrate (Cu(NO₃)₃.3H₂O) was deposited in an identical manner to the cerium oxide additions, to achieve an approximate loading of 5-8% copper metal loading in the cells.

### EXAMPLE 6

### Fuel Cell Testing

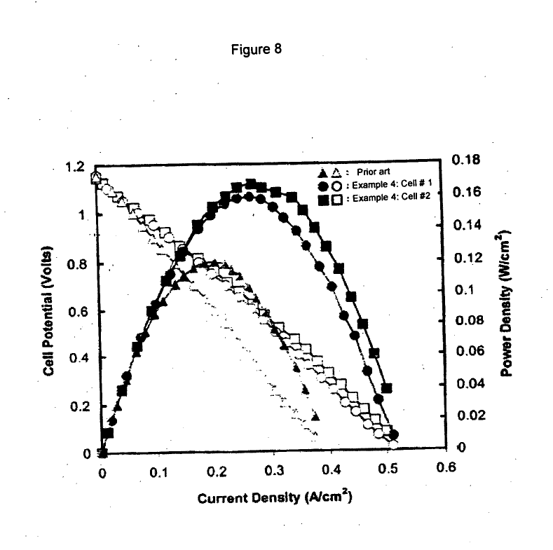

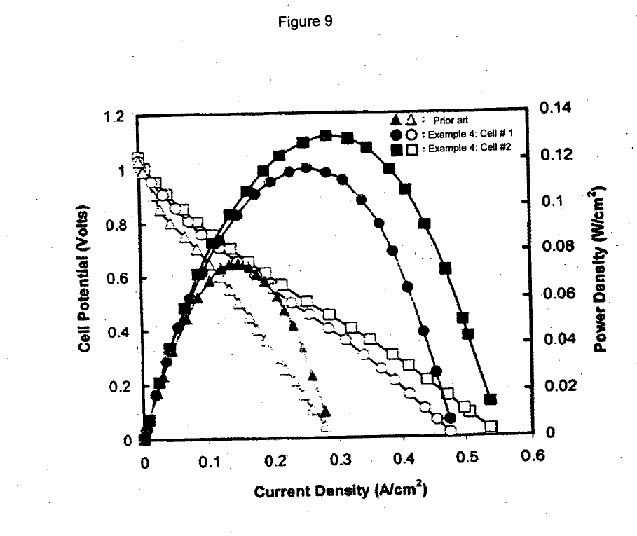

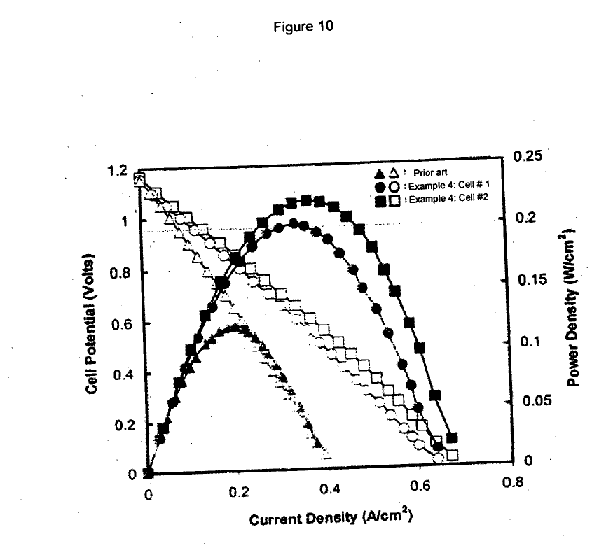

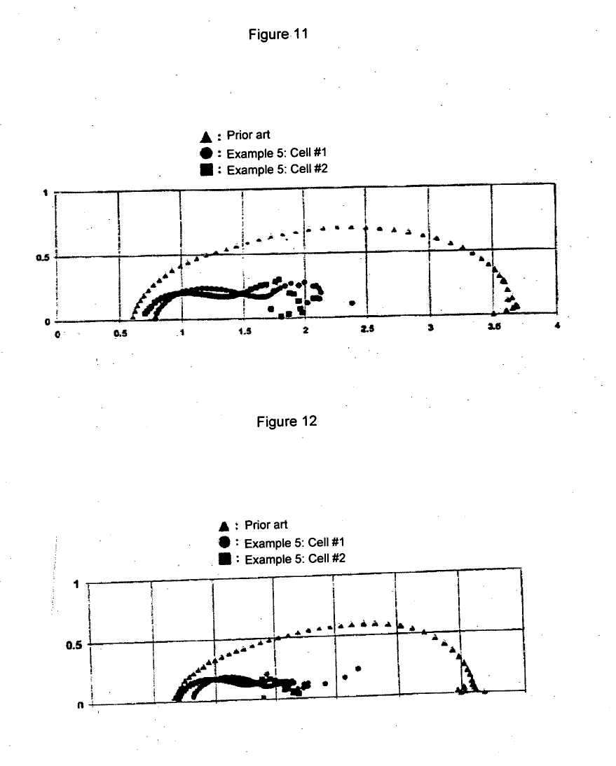

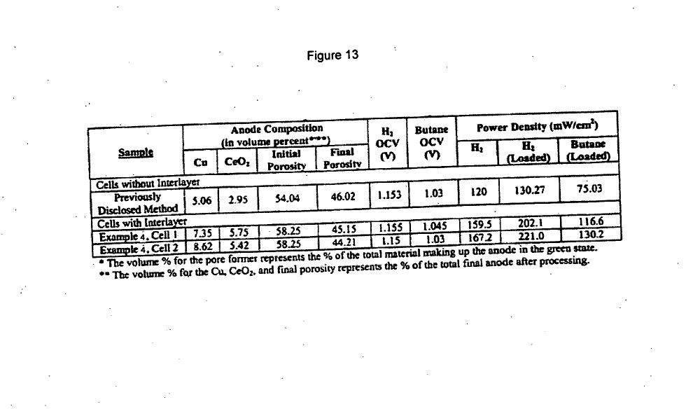

The cells fabricated in Example 5 were prepared for testing by attaching silver leads to the cathode side of the cell, gold leads to the anode side of the cell and sealing the electrolyte to an alumina tube using refractory cement. The cells were first tested by exposing the porous anode side to flowing hydrogen gas while the cathode was exposed to stagnant air in the furnace, at a temperature of 710° C. A power density curve and electronic impedance spectroscopy spectra was obtained, and then the cell was exposed to butane. After approximately 20 minutes exposure to butane at 710° C., the cell was again tested. Finally the fuel gas was switched back to hydrogen and the cell tested once more. The SOFC test results for two fuels of this embodiment are shown in FIGS. 8-10 and the impedance spectroscopy results for butane and hydrogen after butane in FIGS. 11 and 12. A summary of cell performance is listed in FIG. 13.

In general, the SOFC testing demonstrated that cell supports incorporating the interlayer structure can significantly outperform the cells without the interlayer, prior to and after exposure to butane, by 30-70%, depending upon fuel and operating conditions. The electronic impedance spectroscopy shows that the increase in active area provided by the interlayer reduced the resistance of the cells, as indicated by the decrease in low frequency resistance for both testing conditions, (the second lobe of the data). This suggests the interlayer approach increases the effective area for the chemical reactions and that the microstructure of the cell without the interlayer may be significantly less effective at providing rapid electrochemical oxidation of the fuel. Between the two interlayer samples, a slight difference is noted between the bulk resistance values, which may indicate that copper and ceria loading have an effect on bulk cell resistance as well.

Other embodiments, uses, and advantages of the embodiments will be apparent to those skilled in the art from consideration of the specification and practice of the invention disclosed herein. The specification should be considered exemplary only.

What is claimed is:

1. A method of making an article, the method comprising:
forming a first layer comprised of at least first powder having particles of a first size and pore formers of a first size and quantity;
forming a second layer comprised of a second powder having, particles of a second size and pore formers of a second size and quantity;
forming a third layer comprised of a third powder having particles of a third size;
laminating the first, second and third layers together;
heating the first, second and third layers to remove the pore formers;
sintering the first, second and third layers; and
applying a conductive coating to the first layer;
wherein the sintered first layer comprises pore channels that are sufficiently large that a majority of the pore channels remain open after applying the conductive coating;
wherein the sintered second layer comprises a porous interlayer; and
wherein the sintered third layer comprises a ceramic membrane.

2. The method of claim 1, wherein the first powder has an average particle diameter of 20-100 microns.

3. The method of claim 1, wherein the first powder comprises a zirconia powder calcined to form 80-100 micron aggregates.

4. The method of claim 1, wherein the pore channels of the first layer have a low tortuosity.

5. The method of claim 1, wherein the first powder is prepared by a calcination process that reduces a surface area of the first powder and substantially eliminates fine scale porosity in the first layer.

6. The method of claim 1, wherein particles of the first powder have a substantially uniform size and size distribution.

7. The method of claim 1, wherein the pore formers used to form the first layer comprises fugitives.

8. The method of claim 1, wherein the first and second layers comprise an anode, and the conductive coating is applied by infiltrating the pore channels of the first and second layers with cerium and copper nitrate salts.

9. The method of claim 8, wherein the cerium and copper nitrate salts are calcined to decompose the nitrates leaving an oxide phase.

10. The method of claim 1, wherein the second layer comprises yttria stabilized zirconia particles.

11. The method of claim 1, wherein the second powder comprises sub-micron fully stabilized zirconia powder.

12. The method of claim 1, wherein the second powder has an average particle diameter of sub micron dimensions.

13. The method of claim 11, wherein the pore formers used to form the second layer comprise a fine scale fugitive powder that is pyrolyzable.

14. The method of claim 13, wherein the fugitive powder comprises at least one of rice starch and graphite.

15. The method of claim 1, wherein the third powder comprises yttria stabilized zirconia.

16. The method of claim 1, wherein the third powder comprises sub-micron yttria stabilized zirconia.

17. The method of claim 1, wherein a cathode is applied by screen printing a cathode material onto the third layer and firing the cathode material so that it adheres to the third layer.

18. The method of claim 1, wherein the second and third particles have substantially the same particle size.

19. The method of claim 1, wherein the first and second layers comprise a cathode.

20. An article comprising:
a first layer comprising a porous ceramic layer having pore channels, wherein the pore channels are infiltrated with a conductive coating that functions as an anode or cathode, and the pore channels are sufficiently large that a majority of the pore channels remain open after applying the conductive coating;
a second layer positioned on the first layer, the second layer comprising a porous interlayer; and
a third layer comprising a ceramic membrane positioned on the second layer.

21. The article of claim 20, wherein the first layer is formed using a first powder.

22. The article of claim 21, wherein the first powder has an average particle diameter of 20-100 microns.

23. The article of claim 21, wherein the first powder comprises a zirconia powder and is calcined to form 80-100 micron aggregates.

24. The article of claim 20, wherein the pore channels of the first layer have a low tortuosity.

25. The article of claim 21, wherein the first powder includes fugitives.

26. The article of claim 20, wherein the conductive coating functions as an anode, and is applied by infiltrating the pore channels of the first layer with cerium and copper nitrate salts.

27. The article of claim 26, wherein the cerium and copper nitrate salts are calcined to decompose the nitrates leaving an oxide phase.

28. The article of claim 20, wherein the second layer is formed from a second powder.

29. The article of claim 28, wherein the second powder comprises yttria stabilized zirconia particles.

30. The article of claim 29, wherein the second powder further comprises a fine scale fugitive powder that is pyrolyzable.

31. The article of claim 30, wherein the fugitive powder comprises at least one of rice starch and graphite.

32. The article of claim 28, wherein the second powder has an average particle diameter of sub-micron dimensions.

33. The article of claim 20, wherein the third layer is formed from a third powder comprising yttria stabilized zirconia.

34. The article of claim 20, wherein the first and second layers function as an anode, and wherein a cathode is applied by screen printing a cathode material onto the third layer and firing the cathode material so that it adheres to the third layer.

35. The article of claim 20, wherein the conductive coating functions as a cathode.
